(19) United States
(12) Patent Application Publication
(10) Pub. No.: US 2023/0233031 A1
(43) Pub. Date: Jul. 27, 2023

(54) Detachable Food Preparation Handle

(71) Applicant: Christopher Giatti, Mississauga (CA)

(72) Inventor: Christopher Giatti, Mississauga (CA)

(21) Appl. No.: 17/581,552

(22) Filed: Jan. 21, 2022

(51) Int. Cl. A47J 45/07; B25G 3/18

(52) U.S. Cl. CPC A47J 45/07; B25G 3/18

(57) ABSTRACT

A detachable handle for use with at least one food preparation device is disclosed herein. The detachable handle includes a handle body and an attachment mechanism. The detachable handle is preferably used with a set of food preparation devices, such as cookware devices and utensil devices. In some embodiments, the detachable handle is provided with the set of food preparation devices as a food preparation system. The detachable handle may negate a need for permanently attached handles on the cookware devices and utensil devices, and as such may save space and save on materials. Further, the detachable handle may prevent cross contamination between different foods.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of food preparation of existing art and more specifically relates to a detachable handle for use with various food preparation devices.

### RELATED ART

Food preparation devices such as cooking vessels and utensils are used in kitchens worldwide by many—from home cooks to professional chefs. Even for the simplest of meals, often times more than one cooking vessel and more than one utensil is necessary to prepare the meal. For complex meals, the amount of cooking vessels and utensils needed increases. Generally, cooking vessels and utensils are all provided with a handle. This allows for the easy handling of the cooking vessels and utensils and provides convenience in carrying the food preparation devices, for example, if a cooking vessel needs to be transferred from a stove to an oven.

However, the handles are typically fixed to the food preparation devices. This is an issue, particularly for those who store and/or utilize many food preparation devices. For example, the handles are often elongated and thus prevent the food preparation device from fitting properly in a sink. The elongated handles also cause an issue with storage as they take up a lot of room in drawers and cupboards and don't allow for easy stacking. As such, a suitable solution is desired.

### SUMMARY OF THE INVENTION

In view of the foregoing disadvantages inherent in the known food preparation device art, the present disclosure provides a novel detachable food preparation handle. The general purpose of the present disclosure, which will be described subsequently in greater detail, is to provide a detachable handle that can be used with a variety of food preparation devices, such as cookware devices, utensil devices and appliances.

A detachable handle for use with at least one food preparation device is disclosed herein. The detachable handle includes a handle body and an attachment mechanism. The handle body may include a first end opposite a second end and a length therebetween. The handle body may further include a device mating portion located at the first end of the handle body. The device mating portion may be configured to selectively receive a handle mating portion located on the at least one food preparation device. The attachment mechanism may be located on the device mating portion of the handle body and/or the handle mating portion of the at least one food preparation device and may be configured to selectively secure the device mating portion to the handle mating portion.

According to another embodiment, a food preparation system is also disclosed herein. The food preparation system includes a set of food preparation devices and at least one detachable handle. The set of food preparation devices may include at least one cookware device and at least one utensil device, the at least one cookware device and at least one utensil device each including a handle mating portion. The at least one detachable handle may include a handle body. The handle body may have a first end opposite a second end and a length therebetween.

The handle body may further include a device mating portion located at the first end of the handle body. The device mating portion may be configured to selectively receive the handle mating portion from one of the at least one cookware device and the at least one utensil device (one at a time). An attachment mechanism may be located on the device mating portion of the handle body and/or the handle mating portion of the at least one food preparation device and may be configured to selectively secure the device mating portion to the handle mating portion.

According to another embodiment, a method of using a detachable handle with a set of food preparation devices is also disclosed herein. The method includes providing the detachable handle as above; selectively attaching a desired food preparation device from the set of food preparation devices to the detachable handle via the attachment mechanism when needed; selectively using the desired food preparation device; and selectively detaching the desired food preparation device from the detachable handle when not needed.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a detachable food preparation handle, constructed and operative according to the teachings of the present disclosure.

FIG. 1 is a side perspective view of a detachable handle in use with a set of food preparation devices, according to an embodiment of the disclosure.

FIG. 2 is a side perspective view of a food preparation system including the detachable handle and the set of food preparation devices, the set of food preparation devices particularly including at least one cookware device and at least one utensil device, according to an embodiment of the disclosure.

FIG. 3 is a side perspective view of the detachable handle, according to an embodiment of the present disclosure.

FIG. 4 is a top view of the detachable handle, according to an embodiment of the present disclosure.

FIG. 5 is a front view of the detachable handle illustrating an interior slot and an attachment mechanism, according to an embodiment of the present disclosure.

FIG. 6A is a side perspective view of the detachable handle and a handle mating portion prior to insertion into the interior slot of the detachable handle, according to an embodiment of the present disclosure.

FIG. 6B is a cutaway section view of FIG. 6A illustrating the detachable handle and the handle mating portion inserted into the interior slot of the detachable handle, according to an embodiment of the present disclosure.

FIG. 7A is a side view of the detachable handle and the handle mating portion prior to insertion into the interior slot of the detachable handle, according to another embodiment of the present disclosure.

FIG. 7B is a cross section view of FIG. 7A illustrating the detachable handle and the handle mating portion inserted into the interior slot of the detachable handle, according to another embodiment of the present disclosure.

FIG. 8 is a flow diagram illustrating a method of using a detachable handle with a set of food preparation devices, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to food preparation devices and more particularly to a detachable food preparation handle for use with a variety of food preparation devices. For example, the detachable food preparation handle may be switched from a kitchen utensil (such as a spatula or spoon) to a cookware device (such as a pot or a pan) seamlessly. The detachable food preparation handle may negate a need for permanently attached handles on the kitchen utensils, cookware devices and appliances and as such may save sink space when cleaning, save on storage space when being stored and save on materials for manufacture. Further, the detachable food preparation handle may prevent, or at least improve prevention of cross contamination between different foods. In addition, the detachable food preparation handle may provide a safer way to handle a fire as the detachable food preparation handle may inhibit the ability to bring a food preparation device to the sink to exterminate the fire, and thus encourages the user to safely smother the fire.

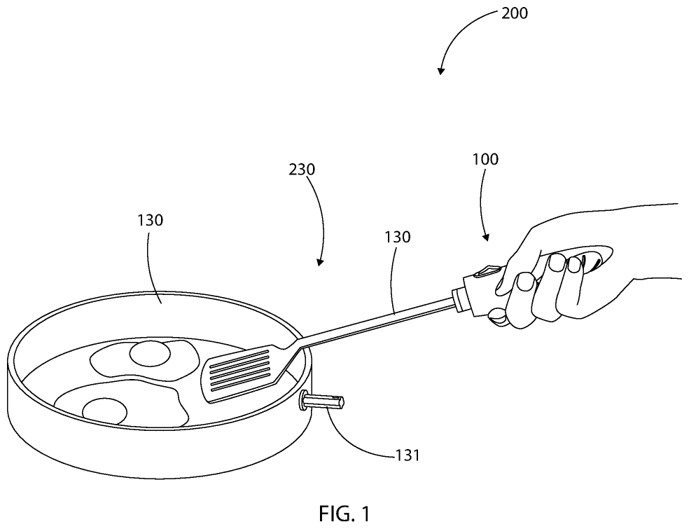

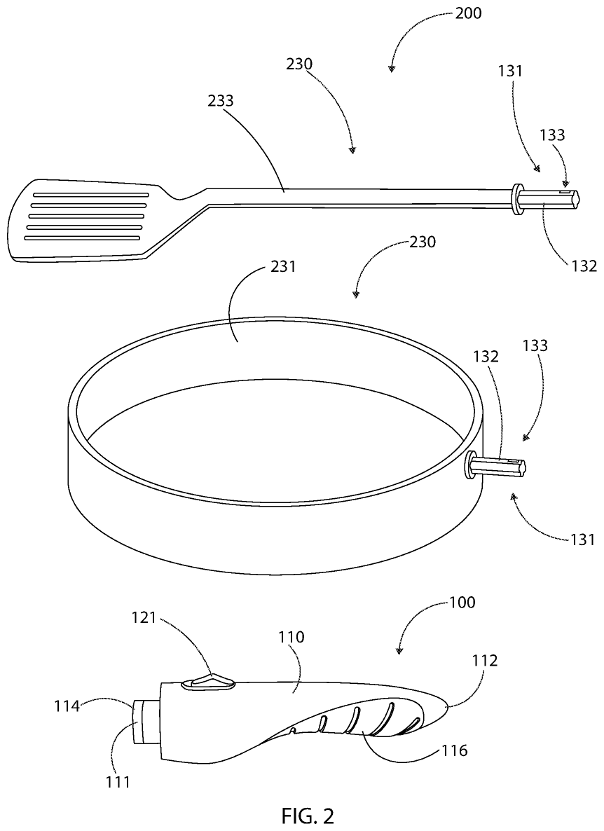

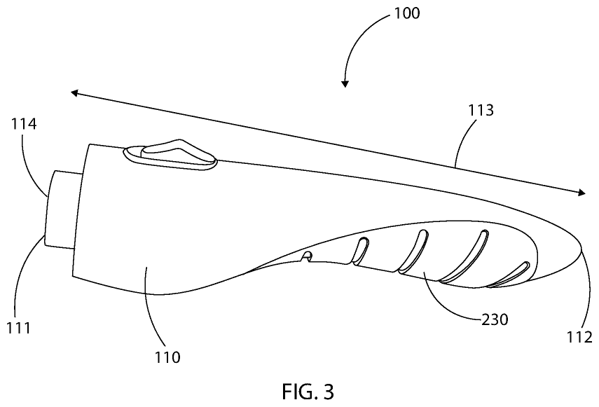

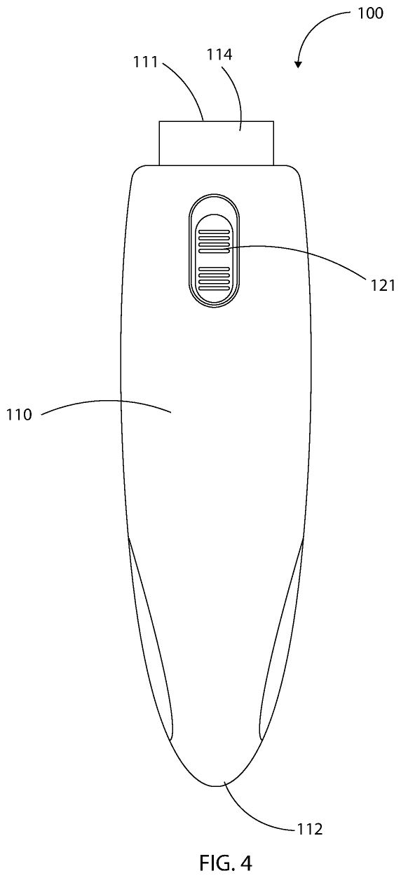

Referring now more specifically to the drawings by numerals of reference, in FIGS. 1-7B, there is shown a detachable handle 100. As shown, the detachable handle 100 may be used with at least one food preparation device 130. For example, FIG. 1 illustrates the detachable handle 100 being used with a spatula. The at least one food preparation may preferably include a set of food preparation devices 230. The food preparation devices contemplated may be any device used in the preparation of food for which a handle is usually required. For example, as shown in FIGS. 1-2, the set of food preparation devices 230 may include at least one cookware device 231 and at least one utensil device 233.

In some embodiments, the detachable handle 100 may be provided separate to existing food preparation devices. In other embodiments, the (at least one) detachable handle 100 may be provided with a set of food preparation devices 230 in a food preparation system 200, as shown in FIGS. 1-2 particularly. In some embodiments, more than one detachable handle 100 may be provided.

Preferably, the at least one cookware device 231 and the at least one utensil device 233 may be a plurality of cookware devices 231 and utensil devices 233. For example, the at least one cookware device 231 may include one or more saucepans, one or more saucepots, one or more sauté pans, one or more woks, one or more frying pans, one or more colanders, one or more Dutch ovens, or the like. The at least one utensil device 233 may include one or more spatulas, one or more spoons, one or more ladles, one or more skewers, one or more measuring cups, one or more whisks, or the like. It should be appreciated that these cookware and utensil devices are given as examples only and that the cookware and utensil devices are not limited to the examples listed here or shown in these figures. Further, in some embodiments, the set of food preparation devices 230 may also include appliances. For example, the appliances may include electric knives, electric blenders, or the like.

As shown in FIGS. 2-5, the detachable handle 100 may include a handle body 110 having a first end 111 opposite a second end 112 and a length 113 therebetween. Preferably, the handle body 110 may also include a user grippable portion 116 terminating at the second end 112 of the handle body 110 to provide a comfortable grip for a user. In some embodiments, the user grippable portion 116 may include a silicone material, a gel material, a foam material, or the like.

It should be appreciated however that the user grippable portion 116 is not limited to these listed material examples.

Further, as shown, the handle body 110 may include a device mating portion 114 located at the first end 111 of the handle body 110. The device mating portion 114 may be configured to selectively receive a handle mating portion 131 located on the at least one food preparation device 130. As above, in some embodiments, the detachable handle 100 may be used with existing food preparation devices. In this embodiment, the handle mating portion 131 may be added as an attachment to the food preparation devices (for example adhesively or magnetically attached) or the handle mating portion 131 may be formed from an existing handle on the existing food preparation device.

In other embodiments, as discussed above, the at least one food preparation device 130 may be a set of food preparation devices 230 particularly including (but not limited to) at least one cookware device 231 and at least one utensil device 233. As shown in FIG. 2 particularly, the at least one cookware device 231 and at least one utensil device 233 may include the handle mating portion 131. As such, the device mating portion 114 may configured to selectively receive the handle mating portion 131 from one of the at least one cookware device 231 and the at least one utensil device 233 (one at a time).

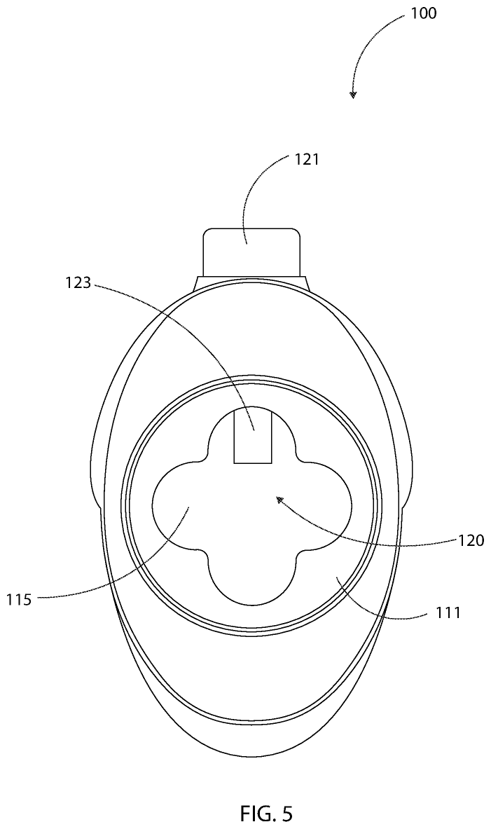

As shown in FIGS. 5-7B particularly, in some embodiments, the device mating portion 114 may be an interior slot 115 disposed at the first end 111 of the handle body 110. As such, the handle mating portion 131 may be a protrusion 132 configured for insertion into the interior slot 115 of the handle body 110. Further, in some embodiments, an attachment mechanism 120 may be located at the device mating portion 114 of the handle body 110 and/or the handle mating portion 131 of the at least one food preparation device 130. The attachment mechanism 120 may be configured to selectively secure the device mating portion 114 to the handle mating portion 131.

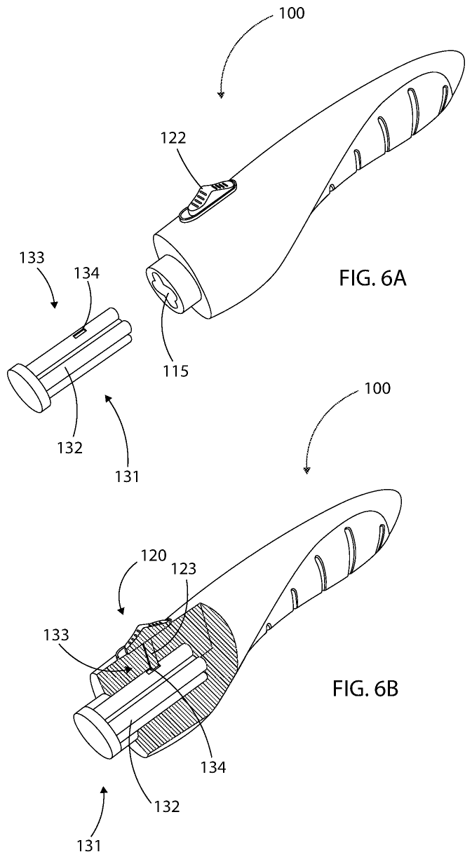

As shown, the attachment mechanism 120 may be located at the device mating portion 114 of the handle body 110. The handle mating portion 131 may include a corresponding attachment mechanism 133 configured to engage with the attachment mechanism 120. For example, as shown in FIGS. 6A-6B, the attachment mechanism 120 may include a latch mechanism 123 and in some embodiments, the corresponding attachment mechanism 133 may include a notch 134 configured to engage with the latch mechanism 123. Further, as shown in these figures, the attachment mechanism 120 may include the device mating portion 114 having a particular shape, and as such, the corresponding attachment mechanism 133 may include the handle mating portion 131 having a corresponding shape.

Further, as shown, the detachable handle 100 may further comprise an attachment control portion 121 disposed on an exterior of the handle body 110. The attachment control portion 121 may be in communication with the attachment mechanism 120 such that the attachment control portion 121 actuates attachment and removal the at least one food preparation device 130. For example, as shown in FIG. 6B particularly, the attachment control portion 121 may include a slidable button 122.

In some instances, the slidable button 122 may be directly attached to the latch mechanism 123 such that a user is able to slide the slidable button 122 in a forward or backward direction to latch onto or unlatch from the notch 134 in the corresponding attachment mechanism 133 (for example, the user may slide the slidable button 122 forward to attach the detachable handle 100 to the at least one food preparation device 130 and may slide the slidable button 122 backwards to detach the detachable handle 100 from the at least one food preparation device 130). It should be appreciated however that the attachment control portion 121 is not limited to a slidable button 122. For example, the attachment control portion 121 may include a de-pressable button, a switch, or the like.

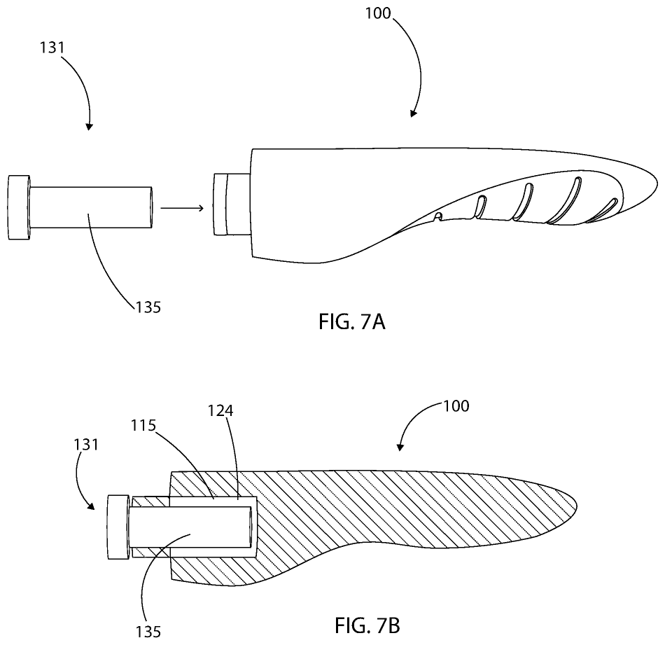

In addition, in some embodiments, the attachment mechanism 120 and the corresponding attachment mechanism 133 may not include the latch mechanism 123 or notch 134. For example, as shown in FIGS. 7A-7B, the attachment mechanism 120 may include a first magnetic material 124 and the corresponding attachment mechanism 133 may include a second magnetic material 135 configured to mate with the first magnetic material 124 (the magnetic materials 124, 135 as such being of opposite polarities). The magnetic materials 124, 135 may provide a strong connection between the detachable handle 100 and the at least one food preparation device 130 such that the user is able to use the at least one food preparation device 130 as regular.

In some examples, to detach the detachable handle 100 from the at least one food preparation device 130, the user may pull, twist, etc. the detachable handle 100 therefrom. In other examples, the magnetic connection may be an electromagnetic connection. In this embodiment, the attachment control portion 121 may be a button or switch used to switch the electromagnetic connection (electrical circuit) on or off.

It should be appreciated that the means of attachment between the detachable handle 100 and the at least one food preparation device 130 (which should be understood to incorporate the at least one cookware device 231 and the at least one utensil device 233) is not limited to what is discussed above. For example, in some embodiments, the at least one food preparation device 130 may include the interior slot and the detachable handle 110 may include the protrusion. In other examples, the means of attachment may include geometric locking, ¼ twist locking, screw(s), friction locking, ball and joint connection, slot and pin connection, click locking systems, plug connections, or the like.

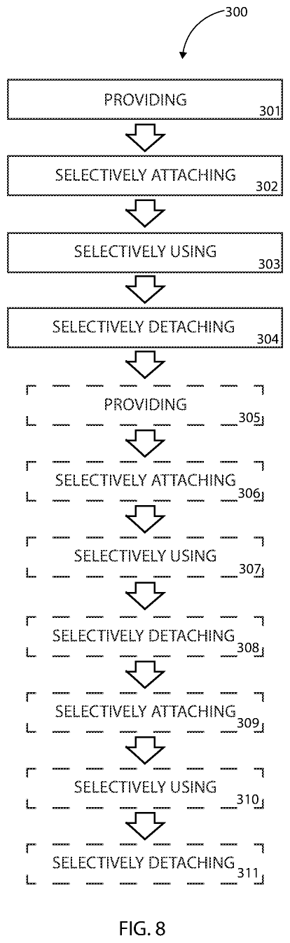

Referring now to FIG. 8 showing a flow diagram illustrating a method 300 of using a detachable handle with a set of food preparation devices, according to an embodiment of the present disclosure. In particular, the method 300 may include one or more components or features of the detachable handle 100 and/or the food preparation system 200 as described above. As illustrated, the method of use 300 may include the steps of: step one 301, providing the detachable handle as above; step two 302, selectively attaching a desired food preparation device from the set of food preparation devices to the detachable handle via the attachment mechanism when needed; step three 303, selectively using the desired food preparation device; and step four 304, selectively detaching the desired food preparation device from the detachable handle when not needed.

Further steps may include: step five 305, providing the set of food preparation devices wherein the set of food preparation devices includes at least one cookware device and at least one utensil device each having a handle mating portion; step six 306, selectively attaching the at least one cookware device to the detachable handle via the attachment mechanism when a cookware device is needed; step seven 307, selectively using the at least one cookware device; step eight 308, selectively detaching the at least one cookware device from the detachable handle when the cookware device is not needed; step nine 309, selectively attaching the at least one utensil device to the detachable handle via the attachment mechanism when a utensil device is needed; step ten 310, selectively using the at least one utensil device; and step eleven 311, selectively detaching the at least one utensil device from the detachable handle when the utensil device is not needed.

It should be noted certain steps may be optional and may not be implemented in all cases. Optional steps of method 300 are illustrated using dotted lines in FIG. 8 so as to distinguish them from the other steps of method 300. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using the detachable handle with a set of food preparation devices are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A detachable handle for use with at least one food preparation device, the handle comprising:
a handle body having a first end opposite a second end and a length therebetween, the handle body further including a device mating portion located at the first end of the handle body, the device mating portion configured to selectively receive a handle mating portion located on the at least one food preparation device;
an attachment mechanism located on at least one of the device mating portion and the handle mating portion, the attachment mechanism configured to selectively secure the device mating portion of the handle body to the handle mating portion of the at least one food preparation device.

2. The detachable handle of claim 1, wherein the at least one food preparation device includes a set of food preparation devices.

3. The detachable handle of claim 2, wherein the set of food preparation devices includes at least one cookware device and at least one utensil device, and wherein each of the at least one cookware device and at least one utensil device includes the handle mating portion.

4. The detachable handle of claim 1, wherein the device mating portion is an interior slot disposed at the first end of the handle body, and wherein the handle mating portion is a protrusion configured for insertion into the interior slot of the handle body.

5. The detachable handle of claim 4, wherein the attachment mechanism is located on the device mating portion, and wherein the handle mating portion includes a corresponding attachment mechanism configured to engage with the attachment mechanism.

6. The detachable handle of claim 5, wherein the attachment mechanism includes a latch mechanism. 7 The detachable handle of claim 6, wherein the corresponding attachment mechanism includes a notch configured to engage with the latch mechanism.

8. The detachable handle of claim 7, further comprising an attachment control portion disposed on an exterior of the handle body, the attachment control portion in communication with the attachment mechanism such that the attachment control portion actuates attachment and removal of the at least one food preparation device.

9. The detachable handle of claim 8, wherein the attachment mechanism includes a first magnetic material and wherein the corresponding attachment mechanism includes a second magnetic material configured to mate with the first magnetic material.

10. The detachable handle of claim 1, wherein the handle body further includes a user grippable portion.

11. A food preparation system comprising:
a set of food preparation devices including at least one cookware device and at least one utensil device, the at least one cookware device and the at least one utensil device each including a handle mating portion;
at least one detachable handle including a handle body, the handle body having a first end opposite a second end and a length therebetween, the handle body further including a device mating portion located at the first end of the handle body, the device mating portion configured to selectively receive the handle mating portion from one of the at least one cookware device and the at least one utensil device; and
an attachment mechanism located on at least one of the device mating portion and the handle mating portion, the attachment mechanism configured to selectively secure the device mating portion to the handle mating portion.

12. The food preparation system of claim 11, wherein the device mating portion is an interior slot disposed at the first end of the handle body, and wherein the handle mating portion is a protrusion configured for insertion into the interior slot of the handle body.

13. The detachable handle of claim 12, wherein the attachment mechanism is located on the device mating portion, and wherein the handle mating portion includes a corresponding attachment mechanism configured to engage with the attachment mechanism.

14. The detachable handle of claim 13, wherein the attachment mechanism includes a latch mechanism.

15. The detachable handle of claim 14, wherein the corresponding attachment mechanism includes a notch configured to engage with the latch mechanism.

16. The food preparation system of claim 15, further comprising an attachment control portion disposed on an exterior of the handle body, the attachment control portion in communication with the attachment mechanism such that the attachment control portion actuates attachment and removal of said one of the at least one cookware device and the at least one utensil device.

17. The food preparation system of claim 15, wherein the attachment mechanism includes a first magnetic material and wherein the corresponding attachment mechanism includes a second magnetic material configured to mate with the first magnetic material.

18. The food preparation system of claim 11, wherein the handle body further includes a user grippable portion.

19. A method of using a detachable handle with a set of food preparation devices, the method comprising the steps of:
providing the detachable handle including:
a handle body having a first end opposite a second end and a length therebetween, the handle body further including a device mating portion located at the first end of the handle body, the device mating portion configured to selectively receive a handle mating portion located on the at least one food preparation device;
an attachment mechanism located on at least one of the device mating portion and the handle mating portion, the attachment mechanism configured to selectively secure the device mating portion of the handle body to the handle mating portion of the at least one food preparation device;
selectively attaching a desired food preparation device from the set of food preparation devices to the detachable handle via the attachment mechanism when needed;
selectively using the desired food preparation device; and
selectively detaching the desired food preparation device from the detachable handle when not needed.

20. The method of claim 19, further comprising the steps of:
providing the set of food preparation devices wherein the set of food preparation devices includes at least one cookware device and at least one utensil device each having the handle mating portion;
selectively attaching the at least one cookware device to the detachable handle via the attachment mechanism when a cookware device is needed;
selectively using the at least one cookware device;
selectively detaching the at least one cookware device from the detachable handle when the cookware device is not needed;
selectively attaching the at least one utensil device to the detachable handle via the attachment mechanism when a utensil device is needed;
selectively using the at least one utensil device; and
selectively detaching the at least one utensil device from the detachable handle when the utensil device is not needed.
